(19) United States
(12) Patent Application Publication
(10) Pub. No.: US 2021/0092602 A1
(43) Pub. Date: Mar. 25, 2021

(54) COMMUNICATION DEVICE, INFORMATION PROCESSING DEVICE, AND COMMUNICATION SETTING METHOD

(71) Applicant: FUJITSU LIMITED, Kawasaki-shi (JP)

(72) Inventor: Yoshinori TANAKA, Yokohama (JP)

(73) Assignee: FUJITSU LIMITED, Kawasaki-shi (JP)

(21) Appl. No.: 17/111,228

(22) Filed: Dec. 3, 2020

Related U.S. Application Data
(63) Continuation of application No. PCT/JP2018/023162, filed on Jun. 18, 2018.

(51) Int. Cl. H04W 12/06; H04W 76/11

(52) U.S. Cl. CPC H04W 12/06; H04W 84/12; H04W 76/11

(57) ABSTRACT

A communication device has a first communication function and a second communication function. The communication device includes a processor. The processor is configured to detect identification information for identifying a specific cell having the second communication function set in advance. The processor is configured to change, in a case of detecting the identification information for identifying the specific cell, connection destination information indicating a connection destination of the communication device to connection destination information corresponding to the specific cell. The processor is configured to perform connection processing and authentication processing with a communication destination via the specific cell, on the basis of the changed connection destination information corresponding to the specific cell. As a result, connection to a local network via the specific cell can be automated.

### CROSS-REFERENCE TO RELATED APPLICATION

This application is a continuation of International Application No. PCT/JP2018/023162, filed on Jun. 18, 2018, the entire contents of which are incorporated herein by reference.

### FIELD

The embodiments discussed herein are related to a communication device, an information processing device, and a communication setting method.

### BACKGROUND

For example, some of PCs (personal computers) such as a notebook PC and a tablet PC have a Wide Area Network (WAN) communication function such as Long Term Evolution (LTE). By using the WAN communication function, these PCs enable communication in areas that are not covered by a WLAN such as outdoor WiFi. On the other hand, a PC not having the WAN communication function uses, in a case of being connected to the WAN, a tethering function of a smartphone and the like to be connected to the WAN via these devices, for example.

In the future, it is expected that a WAN communication environment is secured by constructing a local wireless network such as a private LTE network in an office building or a campus to be connected to a public WAN, and connection is directly made to a local network or the Internet without using a core network of the public WAN via a cell of the local wireless network using a local breakout function. For example, to make a connection to a cell of the local wireless network and perform communication using a local breakout by using a tethering function of a smartphone by a PC, an Access Point Name (APN) for identifying a gateway (GW) that performs local breakout processing in the local wireless network may be changed to a connection destination APN of the smartphone. As a result, the PC communicates with the local network or the Internet via the cell of the local wireless network without using the core network of the public WAN, so that communication charges can be suppressed to be small while reducing an amount of traffic flowing into the core network.

As a mechanism that implements the local breakout function, for example, two types of mechanisms such as Local IP Access (LIPA) and Selected IP Traffic Offload (SIPTO) are standardized by a 3rd Generation Partnership Project (3GPP). With either of the mechanisms, communication can be made with a local network or the Internet via a specific WAN cell without using the core network by using a Radio Access Network (RAN) close to a user or a Local-Gateway (L-GW) installed in the core network. Communication traffic addressed to an APN of the L-GW directly communicates with a local network or the Internet not using the core network, and communication traffic not addressed to the APN of the L-GW communicates with a public network or the Internet via the core network normally. Accordingly, an amount of traffic flowing into the core network can be reduced. Conventional technologies are described in Japanese Laid-open Patent Publication No. 2013-07313, Japanese Laid-open Patent Publication No. 2015-156561, Japanese National Publication of International Patent Application No. 2013-526087, for example.

For example, in a case in which a PC not having a WAN communication function makes a connection to a specific WAN cell using a tethering function of a tethering host device such as a smartphone, the tethering function of the tethering host is manually set to be ON and a WLAN connection destination of the PC is changed to the smartphone.

Additionally, a tethering APN of the tethering host device such as a smartphone at the time of tethering is set to be a tethering APN of a contracted communication provider in advance. However, for example, in a case of making a connection to a specific WAN cell such as a private LTE network connected to a WAN of the communication provider to perform local breakout communication with a local network, an APN at the time of connection to a specific local wireless network is changed to a tethering APN on the local wireless network side using application software and the like of the tethering host.

Additionally, whether the tethering host such as a smartphone is present in an area of the specific local wireless network to be connected is determined by a user of the smartphone by visual check and the like. Thus, in a case of making a tethering connection via the tethering APN on the specific local wireless network side within the area of the specific local wireless network, a setting operation performed by the user is complicated.

### SUMMARY

According to an aspect of an embodiment, a communication device has a first communication function and a second communication function. The communication device includes a processor. The processor is configured to detect identification information for identifying a specific cell having the second communication function set in advance. The processor is configured to change, in a case of detecting the identification information for identifying the specific cell, connection destination information indicating a connection destination of the communication device to connection destination information corresponding to the specific cell. The processor is configured to perform connection processing and authentication processing with a communication destination via the specific cell, on the basis of the changed connection destination information corresponding to the specific cell.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an example of a communication system according to a first embodiment;

FIG. 2 is a block diagram illustrating an example of a hardware configuration of a communication device;

FIG. 3 is a block diagram illustrating an example of a functional configuration of a first CPU in the communication device;

FIG. 4 is a block diagram illustrating an example of a hardware configuration of a PC;

FIG. 5 is a block diagram illustrating an example of a functional configuration of a second CPU in the PC;

FIG. 6 is a flowchart illustrating an example of a processing operation of the first CPU in the communication device related to host-side tethering processing;

FIG. 7 is a flowchart illustrating an example of a processing operation of the second CPU in the PC related to client-side tethering processing;

FIG. 8 is a sequence diagram illustrating an example of a processing operation of the entire communication system according to the first embodiment;

FIG. 9 is an explanatory diagram illustrating an example of a communication system according to a second embodiment;

FIG. 10 is a block diagram illustrating an example of a hardware configuration of the PC;

FIG. 11 is a block diagram illustrating an example of a functional configuration of a third CPU in the PC;

FIG. 12 is a flowchart illustrating an example of a processing operation of the third CPU in the PC related to communication processing;

FIG. 13 is a sequence diagram illustrating an example of a processing operation of the entire communication system according to the second embodiment; and

FIG. 14 is an explanatory diagram illustrating an example of a computer that executes a communication setting program.

### DESCRIPTION OF EMBODIMENTS

Preferred embodiments of the present invention will be explained with reference to accompanying drawings. The technique disclosed herein is not limited to the embodiments. The embodiments described below may be appropriately combined with each other without contradiction.

### [a] First Embodiment

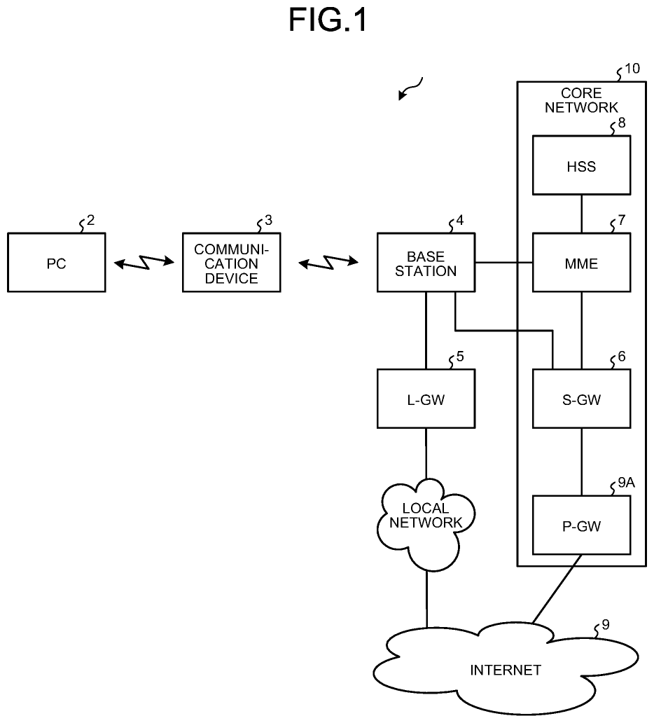

FIG. 1 is an explanatory diagram illustrating an example of a communication system 1 according to a first embodiment. The communication system 1 illustrated in FIG. 1 includes a personal computer (PC) 2, a communication device 3, a base station 4, a Local-Gateway (L-GW) 5, a Serving-Gateway (S-GW) 6, a Mobility Management Entity (MME) 7, and a Home Subscriber Server (HSS) 8. The PC 2 is, for example, an information device such as a tablet PC and a notebook PC having a Wireless Local Area Network (WLAN) communication function but not having a Wide Area Network (WAN) communication function. The communication device 3 is, for example, a communication device such as a smartphone that is connected to the PC 2 in a wireless manner and connected to the base station 4 in a wireless manner. Exemplified is a case in which the communication device 3 is connected to the PC 2 in a wireless manner using a WLAN and the like, but the communication device 3 may be connected to the PC 2 in a wired manner using a USB and the like, and modifications can be appropriately made. The base station 4 is connected, in a wireless manner, to the communication device 3 present in a wireless area governed by itself. The L-GW 5 is a relay device such as an edge device that is connected to the base station 4 and breaks out to a local network or an Internet 9 to be directly connected. The S-GW 6 is a relay device in a core network 10 that is connected to the base station 4, and connected to a P-GW 9A to be connected to the Internet 9 via the P-GW 9A. The core network 10 is, for example, a trunk line network operated by a mobile communication provider. The MME 7 is a control device that manages the entire communication system 1. The HSS 8 is a management device including subscriber information in the communication system 1, for example, a database for managing and registering APN information and the like used by a user. An APN is information for identifying a GW that provides various services, and a communication provider notifies the user of the APN information that is available in the network of its own company. However, local APN information used by the user in a local network is previously notified to the communication provider to be connected by an operation entity of the local network. In a case of detecting a connection request for the APN, the MME 7 refers to a registration state of the HSS 8 and determines whether to make a connection to the APN of the connection request.

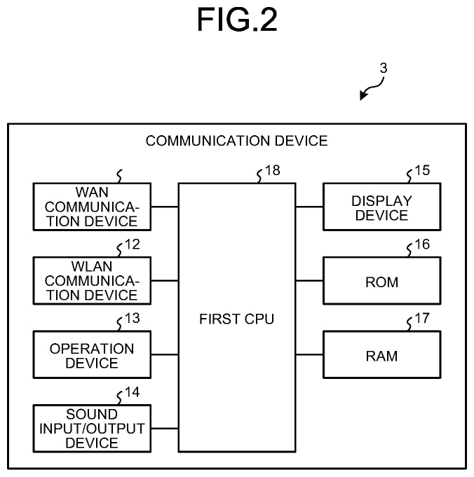

FIG. 2 is a block diagram illustrating an example of a hardware configuration of the communication device 3. The communication device 3 illustrated in FIG. 2 includes a WAN communication device 11, a WLAN communication device 12, an operation device 13, a sound input/output device 14, and a display device 15. Additionally, the communication device 3 includes a read only memory (ROM) 16, a random access memory (RAM) 17, and a first central processing unit (CPU) 18. The WAN communication device 11 is a communication interface (IF) that makes wireless connection with a WAN. The WLAN communication device 12 is a communication IF that makes wireless connection with a WLAN. The operation device 13 is an input IF through which various kinds of information and commands are input. The sound input/output device 14 is an input/output IF such as a speaker that outputs a sound signal and a microphone to which a sound signal is input. The display device 15 is an output IF that displays and outputs various kinds of information. The ROM 16 is a region in which various kinds of information, computer programs, and the like are stored. The RAM 17 is a region in which various kinds of information are stored. The first CPU 18 controls the entire communication device 3.

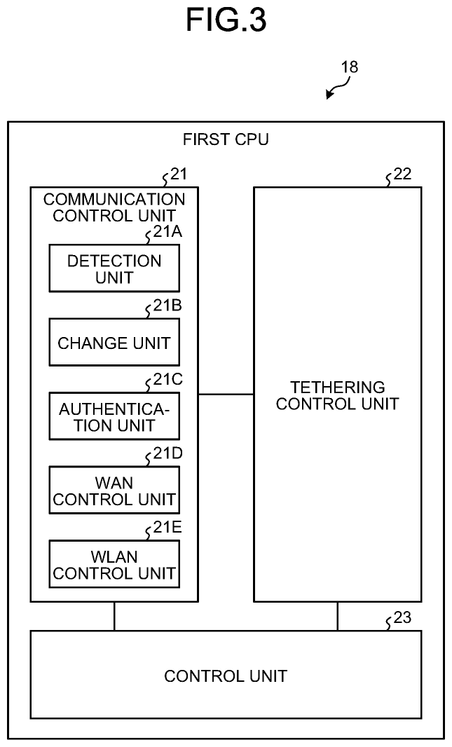

FIG. 3 is a block diagram illustrating an example of a functional configuration of the first CPU 18 in the communication device 3. For example, the first CPU 18 loads a communication setting program stored in the ROM 16 into the RAM 17. The first CPU 18 then executes the communication setting program loaded into the RAM 17 as a communication setting process to execute a communication control unit 21, a tethering control unit 22, and a control unit 23 as functions, for example.

The communication control unit 21 controls a communication function of the entire communication device 3. The communication control unit 21 includes a detection unit 21A, a change unit 21B, an authentication unit 21C, a WAN control unit 21D, and a WLAN control unit 21E. The detection unit 21A detects an E-UTRAN Cell Global Identifier (ECGI) of a surrounding cell. The ECGI is 52-bit information reported by a System Information Block 1 (SIB1) for uniquely identifying a cell, and includes a 24-bit ID of a Public Land Mobile Network (PLMN) and a 28-bit cell ID. The ID of the PLMN is, for example, an ID of a provider code of a cellular telephone. For example, the detection unit 21A previously registers, as a registered ECGI, an ECGI for identifying a WAN cell of a specific local wireless network by application software. The WAN cell of the specific local wireless network is, for example, a WAN cell of a private LTE network. The detection unit 21A determines whether the registered ECGI for identifying the WAN cell of the specific local wireless network is detected. That is, the detection unit 21A determines whether the detected ECGI is the registered ECGI. In a case in which the detected ECGI is the registered ECGI, the detection unit 21A determines that the communication device 3 is present within the WAN cell of the specific local wireless network.

In a case in which the detected ECGI is the registered ECGI, the WLAN control unit 21E sets the WLAN communication function to be ON. In a case in which the detected ECGI is the registered ECGI, the change unit 21B determines whether an available AP of a WLAN is detected. The available AP of the WLAN is an AP of the WLAN that can be used for communication by the communication device 3 at the present point. In a case in which the available AP of the WLAN is not detected, the change unit 21B changes a connection APN as connection information indicating a connection destination of the communication device 3 itself to the APN of the WAN cell of the specific local wireless network. The authentication unit 21C performs authentication processing of authenticating whether the user is allowed to communicate with the WAN cell of the specific local wireless network, on the basis of the APN of the WAN cell of the specific local wireless network after the change. The authentication processing is processing of authenticating whether the user is allowed to communicate with the WAN cell of the specific local wireless network by using a secret key that is previously set by application software. The WAN control unit 21D performs connection processing with the specific WAN cell on the basis of the ECGI of the WAN cell of the specific local wireless network after the change. In a case of detecting the available AP of the WLAN, the WLAN control unit 21E is connected to the available AP of the WLAN. The tethering control unit 22 controls the tethering function to set the tethering function to be ON or OFF. The control unit 23 controls the entire first CPU 18.

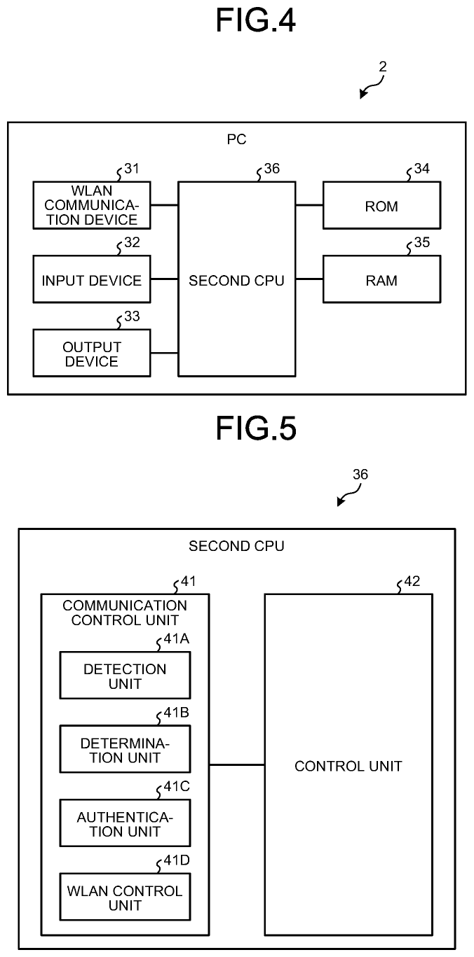

FIG. 4 is a block diagram illustrating an example of a hardware configuration of the PC 2. The PC 2 illustrated in FIG. 4 includes a WLAN communication device 31, an input device 32, an output device 33, a ROM 34, a RAM 35, and a second CPU 36. The WLAN communication device 31 is a communication IF that makes wireless connection with the WLAN. The input device 32 is an input IF through which various kinds of information are input. The output device 33 is an output IF that outputs various kinds of information. The ROM 34 is a region in which various kinds of information, computer programs, and the like are stored. The RAM 35 is a region in which various kinds of information are stored. The second CPU 36 controls the entire PC 2.

FIG. 5 is a block diagram illustrating an example of a functional configuration of the second CPU 36 in the PC 2. For example, the second CPU 36 loads a communication setting program stored in the ROM 34 into the RAM 35. The second CPU 36 executes the communication setting program loaded into the RAM 35 as a communication setting process to execute a communication control unit 41 and a control unit 42 as functions, for example.

The communication control unit 41 includes a detection unit 41A, a determination unit 41B, and an authentication unit 41C. The detection unit 41A detects the available AP of the WLAN. The available AP of the WLAN is an AP of the WLAN that can be used for communication by the PC 2 at the present point. The determination unit 41B determines whether the available AP of the WLAN is only an AP of a tethering host. The tethering host is the AP used for tethering by the PC 2, for example, the communication device 3. In a case in which the available AP of the WLAN is only the AP of the communication device 3 serving as the tethering host, a WLAN control unit 41D performs connection processing with the communication device 3 to perform communication via the WAN cell of the specific local wireless network using the tethering function of the communication device 3. The authentication unit 41C performs authentication processing via the WAN cell of the specific local wireless network via the tethering function of the communication device 3. The control unit 42 controls the entire second CPU 36.

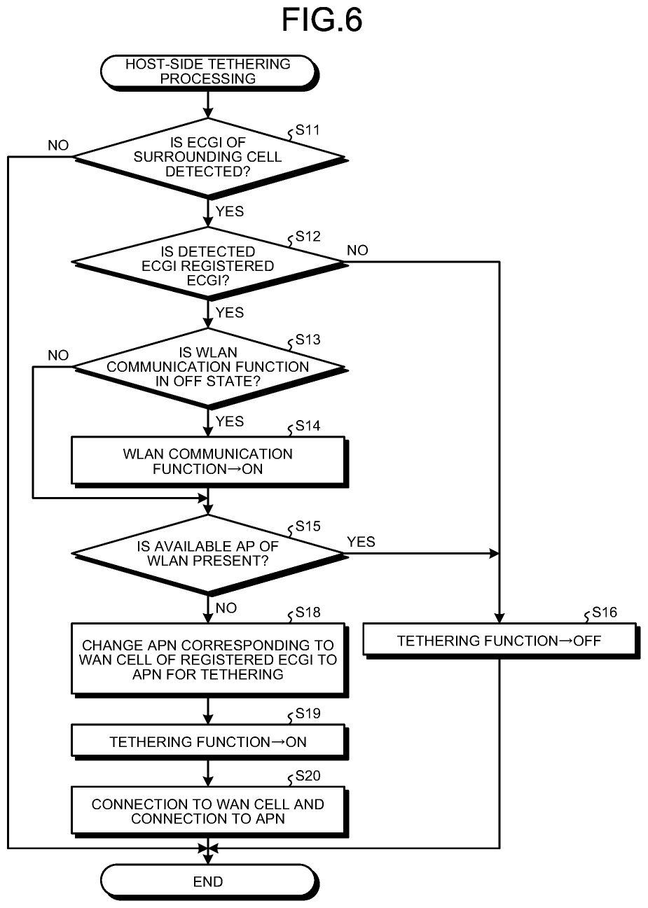

Next, the following describes an operation of the communication system 1 according to the first embodiment. FIG. 6 is a flowchart illustrating an example of a processing operation of the first CPU 18 in the communication device 3 related to host-side tethering processing. The host-side tethering processing illustrated in FIG. 6 is, in a case of detecting the WAN cell of the specific local wireless network, processing of changing the APN for tethering from an APN for tethering of the communication provider to an APN for tethering of the local wireless network, and generating a connection request for the WAN cell of the specific local wireless network.

In FIG. 6, the detection unit 21A in the first CPU 18 in the communication device 3 determines whether the ECGI of the surrounding cell is detected (Step S11). If the ECGI is detected (Yes at Step S11), the detection unit 21A determines whether the detected ECGI is the registered ECGI (Step S12). The registered ECGI is the ECGI of the WAN cell of the available specific local wireless network that is previously registered by the user. The WAN cell of the specific local wireless network is, for example, a WAN cell in a private LTE network.

If the detected ECGI is the registered ECGI (Yes at Step S12), the WAN control unit 21D determines that the communication device 3 is present in the WAN cell of the specific local wireless network, and determines whether the WLAN communication function is in an OFF state (Step S13). If the WLAN communication function is in the OFF state (Yes at Step S13), the WLAN control unit 21E automatically sets the WLAN communication function to be ON (Step S14).

The tethering control unit 22 determines whether the available AP of the WLAN is present (Step S15). If the available AP of the WLAN is present (Yes at Step S15), the tethering control unit 22 sets the tethering function to be OFF (Step S16), and ends the processing operation illustrated in FIG. 6.

If the available AP of the WLAN is not present (No at Step S15), the change unit 21B changes the APN for tethering from the APN for tethering of the communication provider to the APN for tethering of the local wireless network that is associated with the registered ECGI (Step S18). Additionally, the tethering control unit 22 automatically sets the tethering function to be ON (Step S19), generates a connection request for the WAN cell of the specific local wireless network (Step S20), and ends the processing operation illustrated in FIG. 6. The tethering control unit 22 makes a connection with the WAN cell and a connection with the APN.

If the ECGI of the surrounding cell is not detected (No at Step S11), the detection unit 21A ends the processing operation illustrated in FIG. 6. If the WLAN function is not in the OFF state (No at Step S13), the WLAN control unit 21E advances the process to Step S15 to determine whether the available AP of the WLAN is present.

If the detected ECGI is the registered ECGI, the communication device 3 determines that the communication device 3 is present in the WAN cell of the specific local wireless network, and sets the WLAN communication function to be ON. Additionally, in a case of not detecting the AP of the WLAN available for the WLAN communication function, the communication device 3 changes the APN for tethering from the APN for tethering of the communication provider to the APN for tethering of the local wireless network that is associated with the registered ECGI, and sets the tethering function to be ON. As a result, the communication device 3 can recognize that the communication device 3 is present in the area of the WAN cell of the specific local wireless network, and can automatically change the APN for tethering to the APN for tethering of the local wireless network, so that a tethering connection of the PC 2 not having the WAN communication function to the WAN cell of the specific local wireless network can be automated.

In a case in which the available AP of the WLAN is present, the communication device 3 turns OFF the tethering function. The PC 2 can be automatically connected to the available AP of the WLAN normally.

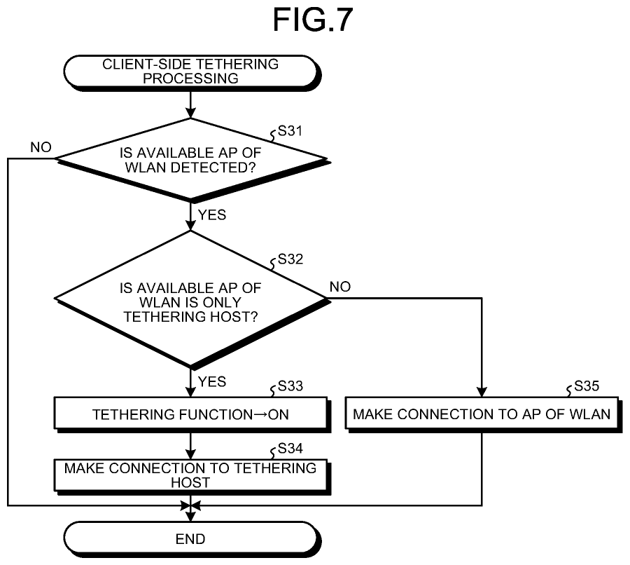

FIG. 7 is a flowchart illustrating an example of a processing operation of the second CPU 36 in the PC 2 related to client-side tethering processing. In FIG. 7, the detection unit 41A in the second CPU 36 in the PC 2 determines whether the available AP of the WLAN is detected (Step S31). If the available AP of the WLAN is detected (Yes at Step S31), the determination unit 41B determines whether the detected AP is only the tethering host (Step S32). The tethering host is, for example, the communication device 3 having the tethering function.

If the detected AP is only the tethering host (Yes at Step S32), the determination unit 41B sets the tethering function to be ON (Step S33). Additionally, the authentication unit 41C performs authentication processing of authenticating whether the user is allowed to communicate with the AP of the tethering host to be connected by the tethering function, and performs communication via the tethering host (Step S34). If the detected AP is not only the tethering host (No at Step S32), the WLAN control unit 41D determines that the detected AP is an AP of a WLAN other than the tethering host, makes a connection with the AP of the WLAN (Step S35), and performs communication using the AP of the WLAN.

In a case in which the available AP of the WLAN is only the tethering host, the PC 2 that performs the client-side tethering processing turns ON the tethering function, and performs authentication processing. As a result, the PC 2 can automatically turn ON the tethering function.

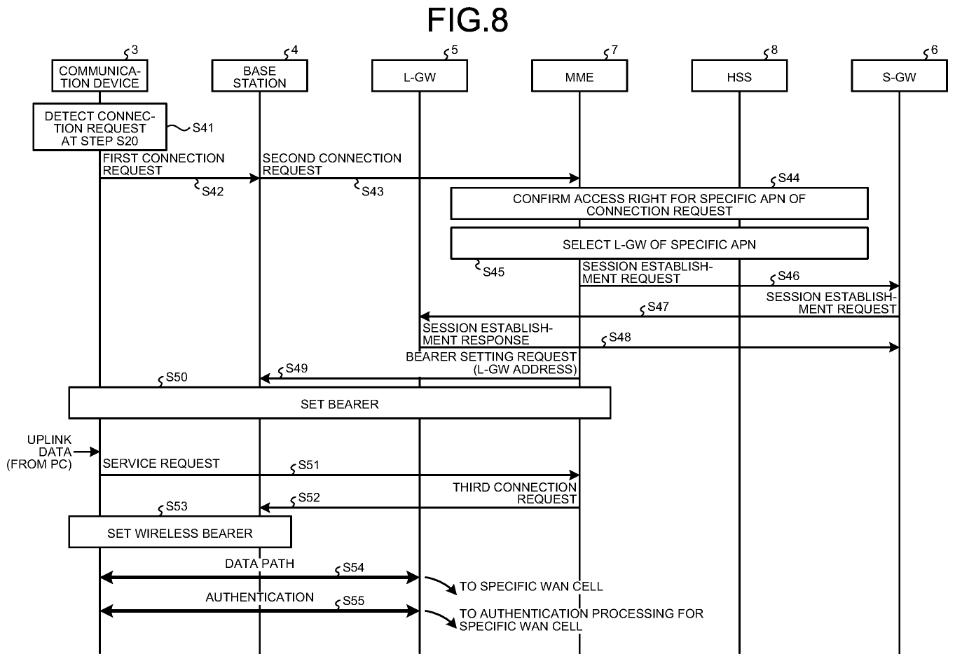

FIG. 8 is a sequence diagram illustrating an example of a processing operation of the entire communication system 1 according to the first embodiment. The communication device 3 detects the connection request (Step S41). The connection request is the connection request generated at Step S20 illustrated in FIG. 6.

In a case of detecting the connection request, the communication device 3 notifies the base station 4 of a first connection request (Step S42). For example, the first connection request includes the APN used in the specific local wireless network to which the registered ECGI belongs. In a case of receiving the first connection request, the base station 4 notifies the MME 7 of a second connection request (Step S43). For example, the second connection request includes the APN used in the specific local wireless network, and an address of the L-GW of the specific local wireless network. An address of the L-GW 5 is not necessarily included therein.

In a case of detecting the second connection request, the MME 7 confirms an access right for a connection request APN (Step S44). Additionally, the MME 7 selects the address of the L-GW 5 in the second connection request, or the address of the L-GW 5 corresponding to the connection request APN (Step S45). After selecting the L-GW 5, the MME 7 notifies the S-GW 6 of a session establishment request for the L-GW 5 (Step S46).

In a case of receiving the session establishment request, the S-GW 6 notifies the L-GW 5 of the session establishment request (Step S47). The L-GW 5 notifies the S-GW 6 of a session establishment response in response to the session establishment request from the S-GW 6 (Step S48).

Next, the MME 7 notifies the base station 4 of a bearer setting request (Step S49). The bearer setting request includes the address of the selected L-GW 5. In a case of receiving the bearer setting request, the base station 4 sets a bearer between itself and each of the communication device 3 and the L-GW 5 (Step S50).

The communication device 3 notifies the MME 7 of a service request via the base station 4 (Step S51). In a case of detecting the service request via the base station 4, the MME 7 notifies the base station 4 of a third connection request (Step S52). The third connection request is assumed to include a Tunnel Endpoint Identifier (TEID) of the L-GW 5 for identifying a session.

In a case of detecting the third connection request, the base station 4 sets a wireless bearer between itself and the communication device 3 (Step S53). The communication device 3 then establishes a data path between itself and the L-GW 5 via the base station 4 (Step S54). Additionally, the communication device 3 performs authentication processing for the specific WAN cell with the L-GW 5 via the base station 4 (Step S55), and performs communication via the L-GW 5.

The communication device 3 performs authentication processing of authenticating whether the user is allowed to communicate with the specific local wireless network with the L-GW5, and in a case in which authentication is completed, data communication with the Internet 9 as a communication destination is established via the base station 4 and the L-GW 5. That is, the PC 2 can communicate with the local network or the Internet 9 via the WAN cell of the specific local wireless network using the tethering function of the communication device 3.

The communication device 3 according to the first embodiment recognizes that the communication device 3 is present in the area of the WAN cell of the specific local wireless network, and in a case of not detecting the available AP of the WLAN, changes the APN for tethering to the APN for tethering of the local wireless network. Additionally, after setting the APN for tethering after the change, the communication device 3 sets the tethering function to be ON. As a result, the PC 2 can communicate with the local network or the Internet 9 via the WAN cell of the specific local wireless network using the tethering function of the communication device 3. That is, even in a case of not having the WAN communication function, the PC 2 can easily implement wireless communication with the specific local wireless network using the tethering function of the communication device 3 without a setting operation.

A connection (including a tethering connection) to the APN that is available for the user can be automated. Even in a case in which the PC 2 does not have the WAN communication function, convenience similar to that in the case of having the WAN communication function can be provided to the user by using the tethering function of the communication device 3. By removing traffic communication via the WAN cell of the specific local wireless network from a charging object of the communication provider, communication charges can be reduced. Additionally, by preventing the traffic via the WAN cell of the specific local wireless network from flowing into the core network 10, the communication provider can reduce a processing load on the core network 10.

The communication device 3 according to the first embodiment described above notifies the MME 7 of the APN corresponding to the detected ECGI. The MME 7 refers to the HSS 8 to confirm whether the APN is the APN that is permitted to be used by the user, and notifies the communication device 3 of the L-GW 5 corresponding to the APN. For example, content of the HSS 8 is assumed to be updated through a setting operation performed by an operation entity of the WAN cell of the specific local wireless network.

As a method of acquiring the APN of the registered ECGI of the communication device 3, for example, a table for managing APN information for each registered ECGI on a cloud may be registered. In this case, the communication device 3 may download the latest table from the cloud, refer to the downloaded table, and acquire the APN information corresponding to the detected ECGI. Also in this case, table content of the cloud is assumed to be updated through a setting operation performed by the operation entity of the WAN cell of the specific local wireless network, for example.

The communication device 3 may also register the table for managing the APN information for each registered ECGI in an Embedded Subscriber Identify Module Card (SIM) (eSIM). In this case, the communication device 3 may download the latest table from the communication provider into the eSIM, or the communication provider may push the information to the eSIM. The communication device 3 may refer to the acquired table, and acquire the APN information corresponding to the detected ECGI. In this case, for example, the table content is updated by a request to the communication provider made by the operation entity of the WAN cell of the specific local wireless network.

In the communication system 1 according to the first embodiment described above, the PC 2 does not have the WAN communication function, so that exemplified is a case in which the PC 2 is directly connected to the local network or the Internet 9 by using the tethering function of the communication device 3. However, in a case in which the PC 2 has the WAN function, the tethering function of the communication device 3 is not necessarily provided, so that an embodiment in such a case will be described below as a second embodiment.

### [b] Second Embodiment

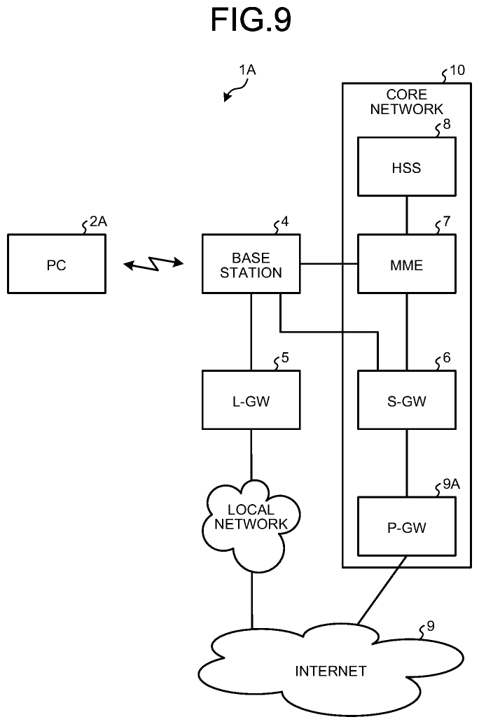

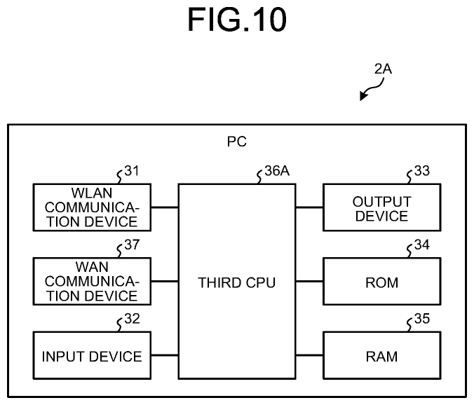

FIG. 9 is an explanatory diagram illustrating an example of a communication system 1A according to the second embodiment. The same configuration as that of the communication system 1 according to the first embodiment is denoted by the same reference numeral, and redundant description about the configuration and the operation will not be repeated. A PC 2A illustrated in FIG. 9 is different from the PC 2 according to the first embodiment in that the PC 2A has the WAN communication function in addition to the WLAN communication function. The PC 2A illustrated in FIG. 10 includes a WAN communication device 37 and a third CPU 36A in addition to the WLAN communication device 31, the input device 32, the output device 33, the ROM 34, and the RAM 35. The WAN communication device 37 is a communication IF that makes a wireless connection with the WAN. The third CPU 36A controls the entire PC 2A.

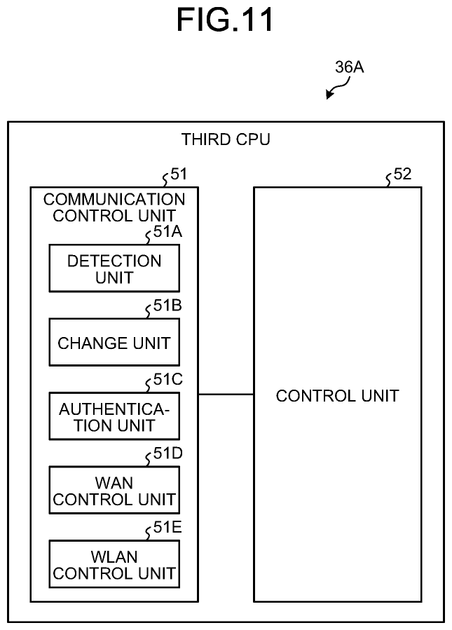

FIG. 11 is a block diagram illustrating an example of a functional configuration of the third CPU 36A in the PC 2A. For example, the third CPU 36A loads a communication setting program stored in the ROM 34 into the RAM 35. The third CPU 36A executes the communication setting program loaded into the RAM 35 as a communication setting process to execute a communication control unit 51 and a control unit 52 as functions, for example.

For example, the communication control unit 51 includes a detection unit 51A, a change unit 51B, an authentication unit 51C, a WAN control unit 51D, and a WLAN control unit 51E. The detection unit 51A detects the ECGI of the surrounding cell. The detection unit 51A is assumed to previously register the ECGI for identifying the WAN cell of the specific local wireless network by using application software. The detection unit 51A determines whether the registered ECGI of the WAN cell of the specific local wireless network is detected. That is, the detection unit 51A determines whether the detected ECGI is the registered ECGI. In a case in which the detected ECGI is the registered ECGI, the detection unit 51A determines that the PC 2A is present in the WAN cell of the specific local wireless network.

In a case in which the detected ECGI is the registered ECGI, the WLAN control unit 51E sets the WLAN communication function to be ON. The WLAN control unit 51E determines whether the available AP of the WLAN is detected. The available AP of the WLAN is an AP that can be used for communication by the PC 2A at the present point. In a case in which the available AP of the WLAN is not detected, the change unit 51B changes a connection APN to an APN on the specific local wireless network side. The authentication unit 51C performs authentication processing of authenticating whether the user is allowed to communicate with the specific local wireless network, on the basis of the changed APN on the specific local wireless network side after the change. The authentication processing is processing of authenticating whether the user is allowed to communicate with the specific local wireless network by using a secret key that is previously set by application software. The WAN control unit 51D performs connection processing with the WAN cell of the specific local wireless network on the basis of the ECGI of the WAN cell of the specific local wireless network after the change. In a case of detecting the available AP of the WLAN, the WLAN control unit 51E is connected to the available AP of the WLAN.

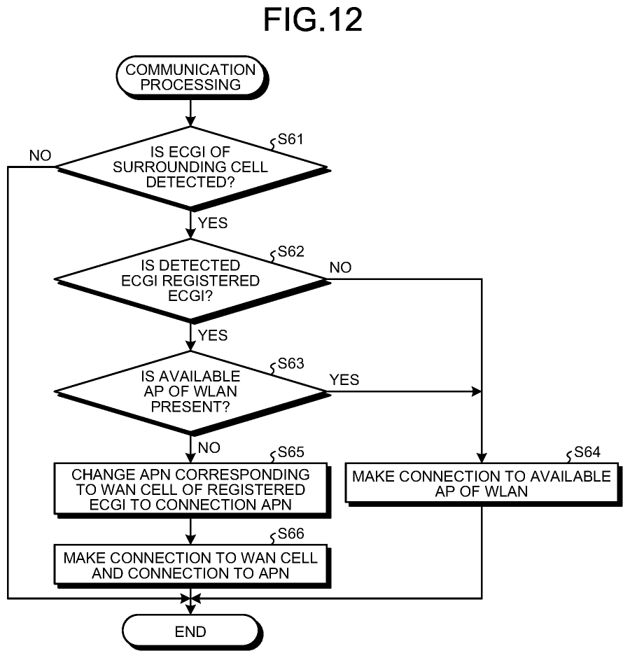

Next, the following describes an operation of the communication system 1 according to the second embodiment. FIG. 12 is a flowchart illustrating an example of a processing operation of the third CPU 36A in the PC 2A related to communication processing according to the second embodiment. The communication processing is, in a case in which the WAN cell of the specific local wireless network is available, processing of changing the APN to be used from the APN of the communication provider to the APN of the local wireless network, and generating a connection request for the WAN cell of the specific local wireless network.

In FIG. 12, the detection unit 51A of the third CPU 36A in the PC 2A determines whether the ECGI of the surrounding cell is detected (Step S61). If the ECGI is detected (Yes at Step S61), the detection unit 51A determines whether the detected ECGI is the registered ECGI (Step S62). The registered ECGI is the ECGI for identifying the WAN cell of the available specific local wireless network that is previously registered by the user.

If the detected ECGI is the registered ECGI (Yes at Step S62), the WLAN control unit 51E determines whether the available AP of the WLAN is present (Step S63). If the available AP of the WLAN is present (Yes at Step S63), the WLAN control unit 51E makes a connection to the available AP of the WLAN (Step S64), and starts communication by the WLAN.

If the available AP of the WLAN is not present (No at Step S63), the change unit 51B changes the APN to be used from the APN of the communication provider to the APN of the local wireless network (Step S65). After changing the connection APN, the change unit 51B generates a connection request for the AP of the WAN cell of the specific local wireless network (Step S66), and starts communication by the WAN. If the ECGI is not detected (No at Step S61), the detection unit 51A ends the processing operation illustrated in FIG. 12.

In a case in which the available AP of the WLAN is not detected, and the WAN cell of the specific local wireless network is detected, the PC 2A that performs communication processing changes the APN to be used from the APN of the communication provider to the APN of the local wireless network, and generates a connection request for the WAN cell of the specific local wireless network. As a result, in a case in which the PC 2A is present in the area of the WAN cell of the specific local wireless network, the PC 2A can automatically change the connection APN to the APN of the specific local wireless network.

In a case in which the available AP of the WLAN is present, the PC 2A can be automatically connected to the available AP of the WLAN.

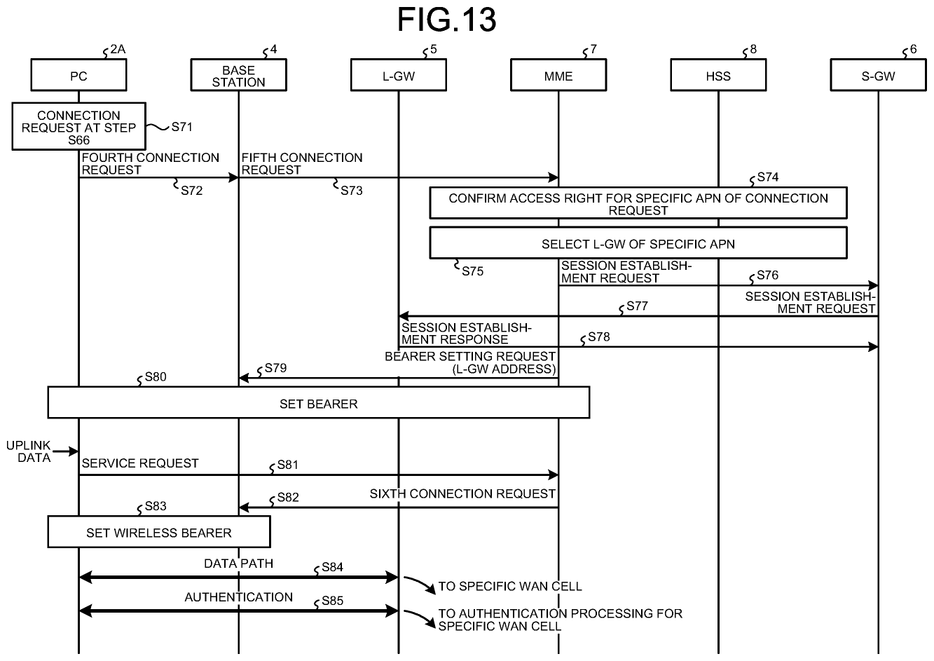

FIG. 13 is a sequence diagram illustrating an example of a processing operation of the entire communication system 1A according to the second embodiment. The PC 2A detects the connection request (Step S71). The connection request is the connection request generated at Step S66 illustrated in FIG. 12.

In a case of detecting the connection request, the PC 2A notifies the base station 4 of a fourth connection request (Step S72). For example, the fourth connection request includes the APN on a side of the specific local wireless network using the registered ECGI. In a case of receiving the fourth connection request, the base station 4 notifies the MME 7 of a fifth connection request (Step S73). The fifth connection request includes, for example, the APN on the local wireless network side.

In a case of detecting the fifth connection request, the MME 7 confirms the access right for the APN on the local wireless network side of the fifth connection request (Step S74). Additionally, the MME 7 selects the L-GW 5 corresponding to the APN on the local wireless network side of the fifth connection request (Step S75). After selecting the L-GW 5, the MME 7 notifies the S-GW 6 of a session establishment request for the L-GW 5 (Step S76).

In a case of receiving the session establishment request, the S-GW 6 notifies the L-GW 5 of the session establishment request (Step S77). In response to the session establishment request from the S-GW 6, the L-GW 5 notifies the S-GW 6 of a session establishment response (Step S78). The MME 7 notifies the base station 4 of a bearer setting request (Step S79). The bearer setting request includes the address of the L-GW 5. In a case of detecting the bearer setting request, the base station 4 sets a bearer between the PC 2A and the L-GW 5 (Step S80).

The PC 2A notifies the MME 7 of a service request via the base station 4 (Step S81). In a case of detecting the service request via the base station 4, the MME 7 notifies the base station 4 of a sixth connection request (Step S82). The sixth connection request is assumed to include the TEID of the L-GW 5. In a case of detecting the sixth connection request, the base station 4 sets a wireless bearer between itself and the PC 2A (Step S83). The PC 2A then establishes a data path for a specific WAN cell between the PC 2A and the L-GW 5 via the base station 4 (Step S84). Additionally, the PC 2A performs authentication processing of authenticating whether the user is allowed to communicate with the specific WAN cell with the L-GW 5 via the base station 4 (Step S85), and performs data communication via the L-GW 5.

The PC 2A performs, with the L-GW 5, authentication processing of authenticating whether the user is allowed to communicate with the specific local wireless network, and in a case in which authentication is completed, data communication with the local network or the Internet 9 as a communication destination is established via the base station 4 and the L-GW 5. That is, the PC 2A can communicate with the local network or the Internet 9 via the WAN cell of the specific local wireless network by using the WAN communication function.

The PC 2A according to the second embodiment recognizes that the PC 2A is present in the area of the WAN cell of the specific local wireless network, and in a case in which the available AP of the WLAN is not detected, changes the APN to be used from the APN of the communication provider to the APN of the local wireless network. Additionally, the PC 2A can communicate with the local network or the Internet 9 via the WAN cell of the specific local wireless network by using the WAN communication function, on the basis of the connection APN after the change. That is, the PC 2A can easily implement communication using the APN on the local wireless network side without a setting operation.

In the first and the second embodiments described above, the local network and the Internet 9 are exemplified as the communication destination of the PC 2 (2A), but the communication destination is not limited thereto, and may be modified as appropriate.

Constituent elements of the respective parts illustrated in the drawings are not necessarily physically configured as illustrated. That is, specific forms of distribution and integration of the respective parts are not limited to those illustrated in the drawings. All or part thereof may be functionally or physically distributed/integrated in arbitrary units depending on various loads or usage states.

Additionally, all or optional part of various processing functions executed by each device may be executed on a central processing unit (CPU) (or a microcomputer such as a micro processing unit (MPU) and a micro controller unit (MCU)). It is obvious that all or optional part of the various processing functions may be executed on a computer program that is analyzed and executed by a CPU (or a microcomputer such as an MPU and an MCU) or on hardware based on wired logic.

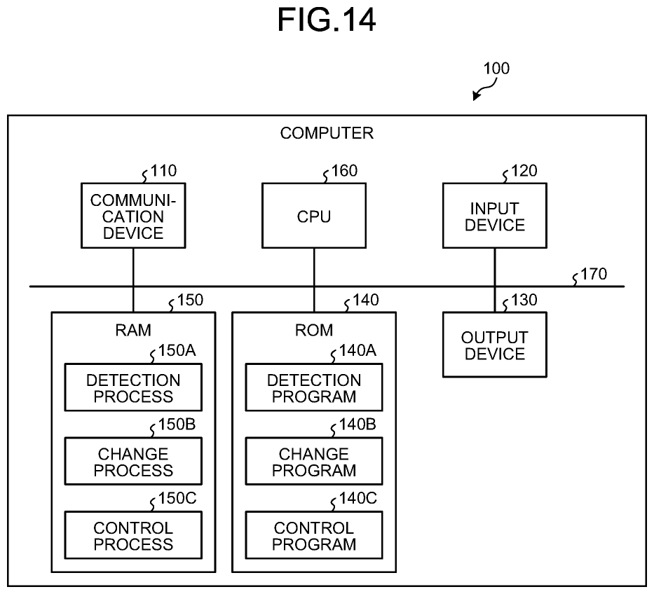

The various kinds of processing described in the embodiments can be implemented by executing a computer program prepared in advance by a computer. Thus, the following describes an example of the computer that executes a computer program having a function similar to that in the embodiments described above. FIG. 14 is an explanatory diagram illustrating an example of a computer 100 that executes a communication setting program.

The computer 100 that executes a communication setting program illustrated in FIG. 14 includes a communication device 110, an input device 120, an output device 130, a ROM 140, a RAM 150, a CPU 160, and a bus 170. The communication device 110 executes a first communication function and a second communication function.

A communication setting program that exhibits a function similar to that in the embodiments described above is stored in the ROM 140 in advance. The communication setting program is not necessarily stored in the ROM 140 from the beginning, and the communication setting program may be recorded in a recording medium that can be read by a drive that is not illustrated. For example, the recording medium may be a portable recording medium such as a flexible disk (FD), a CD-ROM, a DVD disc, a USB memory, an SD card, and an IC card, a semiconductor memory such as a flash memory, and the like. The computer 100 may read out and execute the communication setting program stored in the recording medium. As illustrated in FIG. 14, the communication setting program includes a detection program 140A, a change program 140B, and a control program 140C. 140A to 140C may be integrated or distributed as appropriate.

The CPU 160 then reads out these computer programs 140A to 140C from the ROM 140, and loads the read-out computer programs into a work area of the RAM 150. The RAM 150 functions by the loaded computer programs 140A to 140C as a detection process 150A, a change process 150B, and a control process 150C.

The CPU 160 detects identification information for identifying a specific cell having the second communication function set in advance. In a case of detecting the identification information for identifying the specific cell and not detecting an available communication station of the first communication function, the CPU 160 changes connection destination information indicating a connection destination of the host device to connection destination information corresponding to the specific cell. The CPU 160 performs connection processing and authentication processing with the communication destination via the specific cell, on the basis of the connection destination information corresponding to the specific cell after the change. As a result, communication connection via the specific cell can be automated.

According to one aspect, communication connection via a specific cell can be automated.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication device having a first communication function and a second communication function, the communication device comprising a processor configured to:
detect identification information for identifying a specific cell having the second communication function set in advance;
change, in a case of detecting the identification information for identifying the specific cell, connection destination information indicating a connection destination of the communication device to connection destination information corresponding to the specific cell; and
perform connection processing and authentication processing with a communication destination via the specific cell, on the basis of the changed connection destination information corresponding to the specific cell.

2. The communication device according to claim 1, wherein the processor is further configured to:
set the first communication function to be ON and determine whether an available communication station of the first communication function is detected in a case of detecting the identification information for identifying the specific cell; and
set a tethering function using the second communication function to be ON in a case of not detecting the available communication station of the first communication function, wherein
the changing includes changing, after setting the tethering function to be ON, the connection destination information indicating a connection destination of the tethering function via the specific cell to the connection destination information corresponding to the specific cell.

3. The communication device according to claim 2, wherein
the setting of the tethering function includes setting the tethering function to be OFF in a case of detecting the available communication station of the first communication function, and
the performing includes performing s connection processing and authentication processing with the communication destination via the available communication station of the first communication function.

4. The communication device according to claim 1, wherein the first communication function is a communication function of performing communication via a cell of a Wireless Local Area Network (WLAN), and the second communication function is a communication function of performing communication via a cell of a Wide Area Network (WAN).

5. The communication device according to claim 1, wherein the detecting includes:
acquiring the identification information of the specific cell from a database of a communication provider that stores the identification information of the specific cell, and
setting the acquired identification information of the specific cell in advance.

6. The communication device according to claim 1, wherein the detecting includes:
acquiring the identification information of the specific cell from a cloud configured to manage a table storing the identification information of the specific cell, and
setting the acquired identification information of the specific cell in advance.

7. The communication device according to claim 1, wherein the performing includes performing authentication processing of authenticating whether a user is allowed to communicate with the specific cell by using a secret key.

8. An information processing device having a first communication function and not having a second communication function, the information processing device comprising a processor configured to:
detect an available communication station having the first communication function;
determine whether the available communication station of the first communication function detected by the detection unit is only a communication device in which a tethering function of the second communication function is in an ON state; and
perform, in a case in which the detected available communication station of the first communication function is only the communication device in which the tethering function of the second communication function is in the ON state, communication via the tethering function of the communication device.

9. A communication setting method that is performed by a communication device having a first communication function and a second communication function, the communication setting method comprising:
detecting identification information for identifying a specific cell having the second communication function set in advance;
changing, in a case of not detecting an available relay station of the first communication function, connection destination information indicating a connection destination via the specific cell to connection destination information of the specific cell; and
performing connection processing and authentication processing with a communication destination via the specific cell, on the basis of the changed connection destination information of the specific cell.
